(19) United States
(12) Patent Application Publication
(10) Pub. No.: US 2025/0364623 A1
(43) Pub. Date: Nov. 27, 2025

(54) BATTERY PACK WITH THERMOPLASTIC BARRIER BETWEEN CELLS

(71) Applicant: SABIC GLOBAL TECHNOLOGIES B.V., Bergen op Zoom (NL)

(72) Inventors: Carlos PEREIRA CADENA, Putnam Valley, NY (US); Anil TIWARI, Maastricht (NL); Dinesh MUNJURULIMANA, South Lyon, MI (US)

(21) Appl. No.: 18/998,613

(22) PCT Filed: Jul. 17, 2023
(86) PCT No.: PCT/EP2023/069834

§ 371 Date: Jan. 27, 2025

(30) Foreign Application Priority Data
Jul. 27, 2022 (EP) 22187228.6

(51) Int. Cl. H01M 10/651; H01M 10/643; H01M 10/658; H01M 50/119; H01M 50/213; H01M 50/22; H01M 50/242; H01M 50/293

(52) U.S. Cl. CPC H01M 10/651; H01M 10/643; H01M 10/658; H01M 50/119; H01M 50/213; H01M 50/22; H01M 50/242; H01M 50/293

(57) ABSTRACT

A battery pack is disclosed, having: a cell group, wherein the cell group includes cells respectively defining cylindrical bodies, wherein the cells are encased within respective sleeves, wherein the cells are further encased in a thermoplastic spacer so that the cells are axially parallel to each other and distributed in a planar array, and wherein adjacent ones of the cells are transversely spaced apart from each other by a thermal barrier defining a spacing that is formed by the thermoplastic spacer.

### TECHNICAL FIELD

The aspects herein relate to multi-cell battery packs and more specifically to a battery pack with a thermoplastic barrier between cells of the battery pack.

### BACKGROUND

In battery packs, a short circuit between polar opposite battery electrodes, such as between lithium anodes and cathodes, can lead to thermal runaway reactions, or thermal anomalies, that can generate undesirable temperatures, sometimes in a short time period. Excessive localized heat energy can cause adjacent cells of multi-cell batteries that are not shorted or otherwise damaged to spontaneously begin reacting in a similar fashion. This can cause a phenomenon whereby one cell in thermal runaway can cause adjacent cells to enter thermal runaway. This can result in a cell-to-cell cascade effect. Such a phenomenon can damage components of the battery, or even lead to a general ignition of the battery pack. Thus, it is desirable to restrict the transmission of thermal energy between cells in an effort to block or reduce such runaway reactions.

WO2022072641 discloses a lithium-ion battery assembly includes a plurality of battery cells in a spaced-apart and generally parallel arrangement, each cell of the battery cells extending along a central axis and having a first end portion with a negative terminal and a second end portion with a positive terminal. The assembly includes a first capture plate and a second capture plate, where at least the first capture plate defines capture plate openings corresponding to the plurality of battery cells, the first capture plate spaced from and oriented generally parallel to the second capture plate. Each of the plurality of battery cells extends between the first and second capture plates and is coaxially arranged with one of the capture plate openings in the first capture plate. The assembly optionally includes a body between the capture plates, the body defining a void for each battery cell.

US20180069208A1 discloses a battery pack with cells arranged in an array, but fails to address cell-to-cell thermal runaway beyond simply spacing the cells out of touch with one another. The arrangements disclosed have low thermal mass between cells.

WO2011149075A1 discloses cell carriers sufficient to hold cells in a fixed position, but these cell carriers are thin, have a low heat capacity or thermal mass, and thus do not appear to address cell-to-cell thermal runaway.

US20170301905A1 discloses cell carriers that position cells very close to one another, with little thermal resistance between cells, and thus may not adequately attenuate cell-to-cell thermal runaway.

US20130236759A1 discloses cell carriers that only partially cover cells, and thus may not adequately attenuate cell-to-cell thermal runaway.

### SUMMARY

To address these shortcomings, one may place a thermal barrier or firewall between the cells, however firewalls may be insufficiently thermally insulative, or have too low a thermal mass, to stop cell-to-cell thermal runaway, or they may require undesirable cell spacing, e.g. excessive spacing, to provide adequate thermal resistance.

What is needed is a battery pack construction that selects materials having a specific heat capacity, such that during combustion (e.g. oxidation), cells spaced close together to provide desirable packaging, also provide reduced thermal runaway. This can be provided by restricting heat flow, such as by absorbing heat, such that one cell thermal anomaly does not cause a neighboring cell to enter thermal runaway.

### BRIEF DESCRIPTION OF THE DRAWINGS

The following is a brief description of the drawings wherein like elements are numbered alike and which is presented for the purposes of illustrating the exemplary aspects disclosed herein and not for the purposes of limiting the same.

FIG. 1A is a perspective view of a battery pack according to the present disclosure, and the figure identifies section 1B;

FIG. 1B is a section of the battery pack shown in FIG. 1A:

FIG. 2 is a top view of a battery pack according to the present disclosure;

FIG. 3 is a flowchart showing a method of configuring a battery pack according to the present disclosure; and

FIG. 4 is a perspective view of a thermoplastic encasement for a battery pack according to the present disclosure.

FIG. 5A illustrates a top view of cell testing apparatus, with no cover.

FIG. 5B illustrates a side view of the cell testing apparatus of FIG. 5, shown in a cross-section taken at line B-B, with a cover showing in hidden line.

FIG. 6 illustrates an experimental cell carrier, with no air gap between cells.

FIG. 7 illustrates an experimental cell carrier, with an air gap between cells.

FIG. 8 illustrates an experimental cell carrier, with spaced apart cells disposed in a thermoplastic cell spacer.

FIG. 9A illustrates a top view of an experimental thermoplastic cell separator.

FIG. 9B illustrates a side view of the experimental thermoplastic cell separator of FIG. 9A.

FIG. 10 shows pressure measurements for tests 1-4, as discussed herein.

FIG. 11 shows temperature measurements for tests 1-4, as discussed herein.

FIG. 12 shows pressure measurements for tests 5-7, as discussed herein.

FIG. 13 shows temperature measurements for tests 5-7, as discussed herein.

FIG. 14 shows pressure measurements for tests 8-10, as discussed herein.

FIG. 15 shows temperature measurements for tests 8-10, as discussed herein.

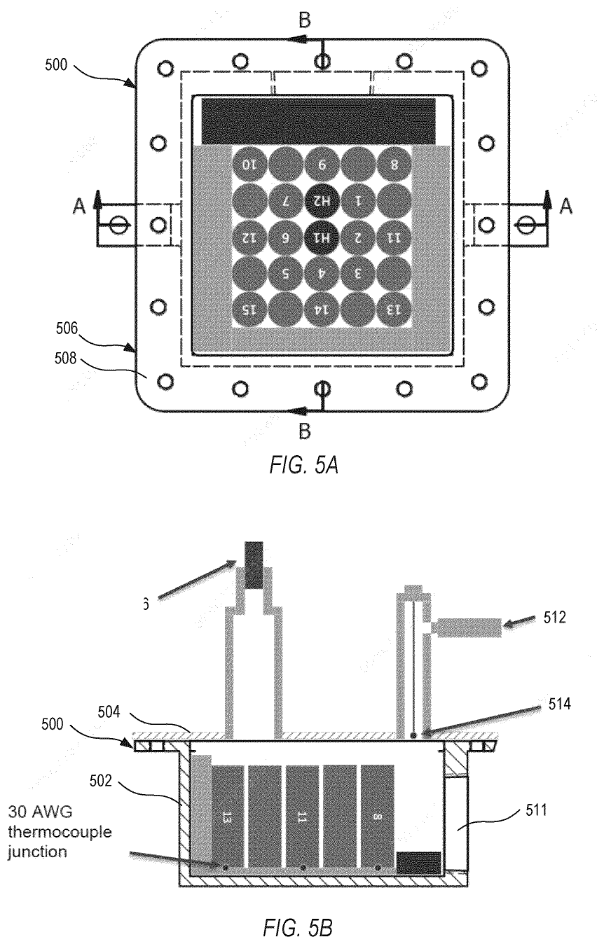

Images in FIGS. 5-15 are provided courtesy of Underwriters Laboratory, LLC.

### DETAILED DESCRIPTION

A detailed description of one or more aspects of the disclosed apparatus and method are presented herein by way of exemplification and not limitation with reference to the Figures.

In multi-cell battery packs (e.g., battery packs with a group of cells), short circuits of battery cells, such as lithium ion (Li) battery cells, can lead to runaway reactions that generate temperatures exceeding 600° C. within 20 to 30 seconds. The temperatures can cause adjacent cells to ignite, such as by causing short circuit, resulting in a cascade that destroys the battery and ignites the battery housing. The utilization of heat sinks, which can be made of aluminum, to increase thermal diffusivity and capacitance, along with low heat conductivity fillers, such as silicone, to limit heat propagation, can be insufficient to minimize heat transferred between cells during these runaway reactions.

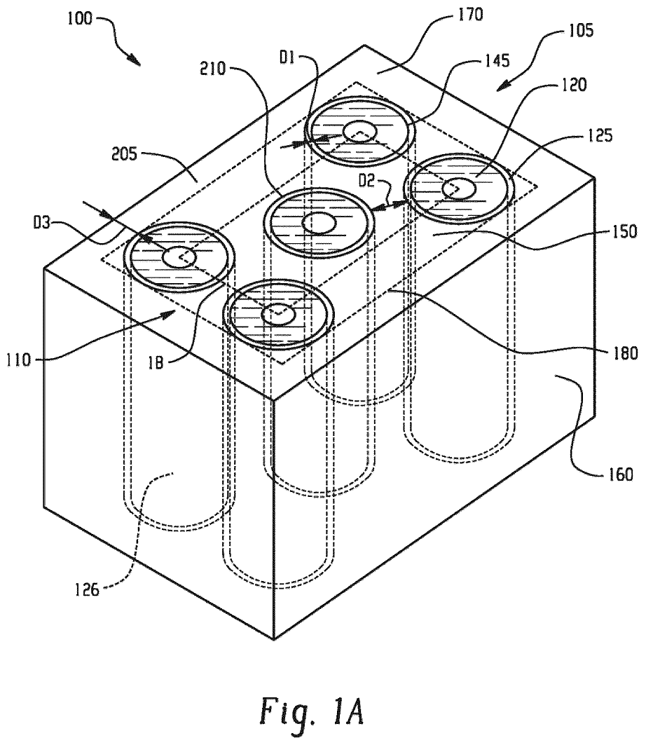

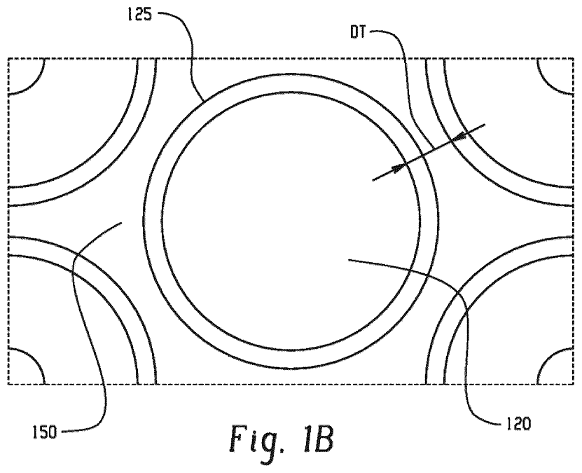

In view of the above concern, FIGS. 1A-1B show a battery pack 100 that can include a cell group 110. The cell group 110 can include one or more cells 120 respectively defining cylindrical bodies 126. The present subject matter is not limited to cylindrical cells, and may be adapted for prismatic cells, but cylindrical cells provide a useful description. Each cell 120 can define an exterior with a height surface extending between upper and lower base surfaces. A plurality of cells, including cell 120, can be arranged in a cell group 110 such that respective lower base surfaces are aligned parallel with one another, as depicted. Each of the cells is associated with thermal runaway potential energy and a thermal runaway ignition energy that includes a cell heating capacity. The thermal runaway ignition energy for a cell is 37 kJ in an example.

The cells 120 can be encased within respective sleeves 125. The sleeve can be a sleeve or sleeve-shaped or define a sleeve. The cells 120 can be further encased in an carrier system 105 that includes a thermoplastic spacer 150. The thermoplastics matrix 150 can be overmolded over the sleeves 125 so that the carrier system 105 is easy to assemble into a battery pack. The cells 120 can be axially parallel to each other and distributed in a planar array. Adjacent ones of the cells 120 can be transversely spaced apart from each other by a thermal barrier defining a spacing of D2 that can be formed by the thermoplastic spacer 150. The sleeve 125 is optional.

An example can include a cell carrier system 105, The example can include a plurality of sleeves 125, each having a sleeve thickness D1, with each of the plurality of cells disposed in a sleeve, wherein each sleeve 125 is associated with sleeve thermal resistance associated with a sleeve heat capacity. The example can include a thermoplastic spacer 150 formed of thermoplastic and joined with the plurality of sleeves to define the cell carrier, wherein the thermoplastic spacer comprises a thermoplastic thermal resistance associated with a pre-pyrolysis heat capacity including a latent heat of fusion, and a pyrolysis heat capacity. In an example the cell carrier can define cell-to-cell spacing D2 between adjacent cells, and for each cell the respective base surfaces are exposed while respective height surfaces are shielded from the height surfaces of adjacent cells by the cell carrier. The example can be characterized in that the sleeve, sleeve thickness D1, cell-to-cell spacing D2, and the thermoplastic spacer are selected such that the sleeve thermal resistance and the thermoplastic thermal resistance provide a combined thermal resistance to restrict heat flow from a cell in thermal runaway, to an adjacent cell or cells, such that the thermal runaway potential energy of the cell in thermal runaway, as restricted, is less than the thermal runaway ignition energy of the adjacent cell or cells during a thermal runaway event.

The cells 120 can have a same size and shape as each other. In a multi-part design, an outer shell 160 can surround the thermoplastic spacer 150. The outer shell 160 can be of the same material as the sleeves 125. The outer shell 160 can be a different material from the sleeves 125. The outer shell 160 can be snap-fit to the carrier, adhered, or otherwise fastened to the cell carrier system 105. Material properties of the thermoplastic spacer 150 can include one or more of: a melting point of 110° C. to 300° C., or 110° C. to 270° C., for example, 130° C.: a heat capacity of 1400 to 2400 kilojoules per kilogram Kelvin (kJ/kg K), for example, 2200 kJ/kg K: a heat of fusion at least 120 Joules per gram (J/g): or a pyrolysis temperature of at least 300° C.

The thermoplastic spacer 150 can be formed of a polymeric composition comprising a thermoplastic polymer. The thermoplastic polymer is not particularly limited and can include at least one of a polyacetal, a polyacrylic, a polycarbonate, a polystyrene, a polyester, a polyamide, a polyamideimide, a polyarylate, a polyarylsulfone, a polyethersulfone, a polyphenylene sulfide, a polysulfone, a polyimide, a polyetherimide, a fluoropolymer (for example, polytetrafluoroethylene), a polyetherketone, a polyether ether ketone, a polyether ketone ketone, a polybenzoxazole, a polyoxadiazole, a polybenzimidazole, a polyacetal, a polyanhydride, a poly(vinyl ether), a poly(vinyl thioether), a poly(vinyl alcohol), a poly(vinyl ketone), a poly(vinyl halide), a poly(vinyl nitrile), a poly(vinyl ester), a polysulfonate, a polysulfide, a polysulfonamide, a polyurea, or a polyphosphazene. The thermoplastic polymer can include a polyolefin, a polycarbonate, a polysulfone, a polyetherimide, a polyamide, a polyester (for example, poly(ethylene terephthalate) or poly(butylene terephthalate), a polystyrene, a polyether (for example, a polyether ketone or a polyether ether ketone), or a polyacrylate (for example, poly(methyl methacrylate).

The thermoplastic polymer can comprise a polyolefin. The polyolefin comprises at least one of a homopolymer or a copolymer. The polyolefin can be of the general structure: CₙH₂ₙ, where n can be 2 to 20. The polyolefin can include at least one of a polyethylene, a polypropylene, a polyisobutylene, or a polynorbornene. Examples of polyethylene include linear low density polyethylene (LLDPE), high density polyethylene (HDPE), and medium density polyethylene (MDPE). The polyolefin can include a polyolefin copolymer, for example, copolymers of ethylene and at least one of propene, 1-butene, 1-octene, 1-decene, 4-methylpentene-1, 2-butene, 1-pentene, 2-pentene, 1-hexene, 2-hexene, 3-hexene, norbornene, or a diene (for example, 1,4 hexadiene, monocylic or polycyclic dienes). The polyolefin copolymer can include a heterophasic polyolefin, the thermoplastic polymer can include a polyethylene.

The thermoplastic composition can include an additive. The additive can include at least one of a foaming agent, a flame retardant, an impact modifier, flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, anti-drip agent (e.g., a PTFE-encapsulated styrene-acrylonitrile copolymer (TSAN)), or a combination thereof. For example, a combination of a heat stabilizer, mold release agent, and ultraviolet light stabilizer can be used. In general, the additives are used in the amounts generally known to be effective.

The thermoplastic composition can include a foaming agent that, e.g., foams at about 240° C. The presence of the foaming agent can function to absorb heat energy to potentially prevent thermal runaway or to prevent oxygen from contacting the surface of the polymer during combustion (intumescence). The foaming agent can include a solid foaming agent, a liquid foaming agent, or a supercritical foaming agent. The foaming agent can be a solid at room temperature and, when heated to temperatures higher than its decomposition temperature, generate a gas (for example, nitrogen, carbon dioxide, or ammonia gas), such as azodicarbonamide, metal salts of azodicarbonamide, 4,4′ oxybis(benzenesulfonylhydrazide), sodium bicarbonate, ammonium carbonate, or the like. The foaming agent can include at least one of an inorganic agent or an organic agents. Examples of inorganic blowing agents include carbon dioxide, nitrogen, argon, water, air, nitrogen, ammonia, and inert gases for example helium and argon. Examples of organic agents include aliphatic hydrocarbons having 1 to 9 carbon atoms, aliphatic alcohols having 1 to 3 carbon atoms, and fully and partially halogenated aliphatic hydrocarbons having 1 to 4 carbon atoms. Examples of aliphatic hydrocarbons include methane, ethane, propane, n-butane, isobutane, n-pentane, isopentane, neopentane, and the like. Examples of aliphatic alcohols include methanol, ethanol, n-propanol, and isopropanol. Examples of fully and partially halogenated aliphatic hydrocarbons include fluorocarbons, chlorocarbons, and chlorofluorocarbons. Examples of fluorocarbons include methyl fluoride, perfluoromethane, ethyl fluoride, 1,1-difluoroethane, 1,1,1-trifluoroethane, 1,1,1,2-tetrafluoro-ethane, pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane, and the like. Examples of partially halogenated chlorocarbons and chlorofluorocarbons include methyl chloride, methylene chloride, ethyl chloride, 1,1,1-trichloroethane, 1,1-dichloro-1-fluoroethane, 1-chloro-1,1-difluoroethane, chlorodifluoromethane, 1,1-dichloro-2,2,2-trifluoroethane, 1-chloro-1,2,2,2-tetrafluoroethane, and the like. Examples of fully halogenated chlorofluorocarbons include trichloromonofluoromethane, dichlorodifluoromethane, trichlorotrifluoroethane, 1,1,1-trifluoroethane, pentafluoroethane, dichlorotetrafluoroethane, chloroheptafluoropropane, and dichlorohexafluoropropane. Examples of other chemical agents include azodicarbonamide, azodiisobutyronitrile, benzenesulfonhydrazide, 4,4-oxybenzene sulfonyl-semicarbazide, p-toluene sulfonyl semi-carbazide, barium azodicarboxylate, N,N′-dimethyl-N,N′-dinitrosoterephthalamide, trihydrazino triazine, and the like.

The thermoplastic composition can include a flame retardant. Useful flame retardants include organic compounds that include chlorine, bromine, or phosphorus. The flame retardant can include at least one of a halogenate flame retardant, a phosphorus containing flame retardant, or an inorganic flame retardant. Non-brominated and non-chlorinated phosphorus-containing flame retardants can be preferred in certain applications for regulatory reasons, for example organic phosphates and organic compounds containing phosphorus-nitrogen bonds.

Examples of halogenated flame retardants include bisphenols of which the following are representative: 2,2-bis-(3,5-dichlorophenyl)-propane: bis-(2-chlorophenyl)-methane: bis(2,6-dibromophenyl)-methane: 1,1-bis-(4-iodophenyl)-ethane: 1,2-bis-(2,6-dichlorophenyl)-ethane: 1,1-bis-(2-chloro-4-iodophenyl) ethane: 1,1-bis-(2-chloro-4-methylphenyl)-ethane: 1,1-bis-(3,5-dichlorophenyl)-ethane: 2,2-bis-(3-phenyl-4-bromophenyl)-ethane: 2,6-bis-(4,6-dichloronaphthyl)-propane; and 2,2-bis-(3,5-dichloro-4-hydroxy phenyl)-propane 2,2 bis-(3-bromo-4-hydroxy phenyl)-propane. Other halogenated materials include 1,3-dichlorobenzene, 1,4-dibromobenzene, 1,3-dichloro-4-hydroxy benzene, and biphenyls such as 2,2′-dichlorobiphenyl, poly brominated 1,4-diphenoxy benzene, 2,4′-dibromobiphenyl, and 2,4′-dichlorobiphenyl as well as decabromo diphenyl oxide, as well as oligomeric and polymeric halogenated aromatic compounds, such as a copolycarbonate of bisphenol A and tetrabromobisphenol A and a carbonate precursor, e.g., phosgene. Metal synergists, e.g., antimony oxide, can also be used with the flame retardant. When present, halogen containing flame retardants can be present in amounts of 1 to 25 parts by weight, or 2 to 20 parts by weight, based on 100 parts by weight of the total composition, excluding any filler.

Alternatively, the thermoplastic composition can be essentially free of chlorine and bromine. “Essentially free of chlorine and bromine” is defined as having a bromine or chlorine content of less than or equal to 100 parts per million by weight (ppm), less than or equal to 75 ppm, or less than or equal to 50 ppm, based on the total parts by weight of the composition, excluding any filler.

The flame retardant can comprise a phosphorus containing flame retardant. Flame retardant aromatic phosphates include triphenyl phosphate, tricresyl phosphate, isopropylated triphenyl phosphate, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri (nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, and 2-ethylhexyl diphenyl phosphate. Di- or polyfunctional aromatic phosphorus-containing compounds are also useful, for example resorcinol tetraphenyl diphosphate (RDP), the bis(diphenyl) phosphate of hydroquinone and the bis(diphenyl) phosphate of bisphenol A, respectively, and their oligomeric and polymeric counterparts. Flame retardant compounds containing phosphorus-nitrogen bonds include phosphonitrilic chloride, phosphorus ester amides, phosphoric acid amides, phosphonic acid amides, phosphinic acid amides, and tris(aziridinyl) phosphine oxide. The aromatic phosphate can include a di- or polyfunctional compound or polymer. When used, phosphorus-containing flame retardants can be present in amounts of 0.1 to 30 parts by weight, or 1 to 20 parts by weight, based on 100 parts by weight of the total composition, excluding any filler.

Inorganic flame retardants include salts of C₁₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate: salts such as Na₂CO₃, K₂CO₃, MgCO₃, CaCO₃, and BaCO₃, or fluoro-anion complexes such as Li₃AlF₆, BaSiF₆, KBF₄, K₃AlF₆, KAlF₄, K₂SiF₆, or Na₃AlF₆. When present, inorganic flame retardant salts can be present in amounts of 0.01 to 10 parts by weight, or 0.02 to 1 parts by weight, based on 100 parts by weight of the total composition, excluding any filler.

The thermoplastic composition can have a UL94 flame rating of VO or better at a non-limiting thickness of 3.5 millimeters (mm), preferably 2 mm, or 1.5 mm, or 1 mm, or less, as measured in accordance with the Underwriter's Laboratory Bulletin 94 (UL94) entitled “Tests for Flammability of Plastic Materials for Parts in Devices and Appliances” (ISBN 0-7629-0082-2), Fifth Edition, Dated Oct. 29, 1996, incorporating revisions through and including Dec. 12, 2003.

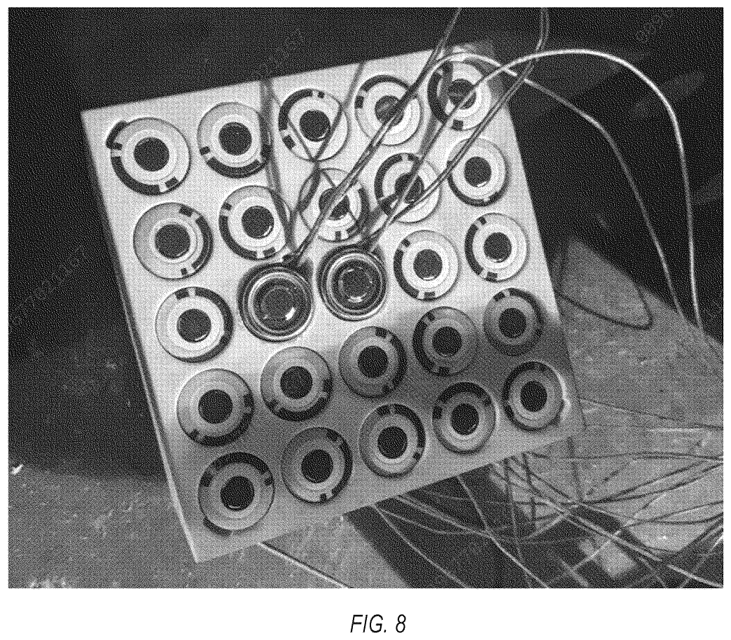

In some examples, discussed in greater detail below, the thermoplastic spacer 150 can be formed of a spacer 205 of the thermoplastic composition that defines cylindrical recesses 210 respectively configured to receive the cells 120. Test results are provided herein that reference a spacer without sleeves, see for example, FIG. 8. In any case, test results are useful for showing the underlying potential heat capacity of a thermoplastic spacer.

The sleeves 125 can be respectively formed by cylindrical walls 145 that respectively define a wall thickness having a sleeve size or material thickness of D1. In some examples, D2>D1. D2 can be at least 2.5 millimeters (mm). The summation of these thicknesses may be considered DT, i.e., DT=D1+D2 (FIG. 1B). D1 can be 0.5 to 1.5 mm, for example, 0.8 mm. D2 can be at least 3.5 mm. D2 is more clearly shown in FIG. 1B. FIG. 1B represents a repeating pattern in the battery pack 100 and shows an area of the battery pack 100 that is utilized for the calculations that apply D2 and DT. In some aspects, D2, representing a contribution from the thermoplastic spacer 150, is the primary variable in calculations involving absorption of heat energy from a runaway cell. Thus, in some examples, D2 defines a minimum thickness to form the battery pack 100 and also the minimum thickness to meet flame retardancy requirements. For some aspects, between adjacent ones of the cells 120, the thermoplastic spacer 150, and the sleeves 125 together can form a combined heat capacity of at least 37 kJ. The sleeves 125 can be formed of aluminum. The sleeves 125 can be formed of anodized aluminum.

With the above disclosed aspects, the sleeves 125 are respectively utilized to accommodate multiple cells 120 that can be cylindrical or occupy other envelopes (or, e.g., to stack prismatic or pouch cells). The disclosed aspects therefore involve filling the space between cells 120 with thermoplastic of the thermoplastic spacer 150. The thermoplastic spacer 150 can provide thermal capacitance in order to absorb heat. The ability to absorb heat during a cell runaway can be increased by the thermoplastic latent heat of fusion, e.g., if/when the temperature exceeds its pyrolysis temperature, i.e., at least 300° C., by the heat of pyrolysis. The utilization of the sleeves 125 (e.g. anodized aluminum) to spread heat and contain molten plastic can be advantageous. The carrier system 105 can be manufactured by molding a spacer of the thermoplastic composition and then forming the openings to receive the cells 120, for example, by drilling. Conversely, the thermoplastic composition can be molded in a form defining the openings. The sleeves 125 can be present during the forming of the carrier system 105, for example, being present in the mold during injection of the thermoplastic composition or can be subsequently added to the opening, for example, by adding a preformed metal layer to the cylindrical walls 145 or by depositing (for example, by sputter coating) a metal layer onto the cylindrical walls.

The heat generated by a runaway cell has been measured at around 36 kilojoules (kJ), resulting from electrochemical heat measured to be around 9.5 kJ, and decomposition heat measured to be around 26.8 kJ. In order to stop or minimize heat propagation, the heat capacity of the combination of the thermoplastic spacer 150 and the sleeve 125 can be such that energy is absorbed. The heat capacity of the thermoplastic spacer 150 and the sleeve 125 can be calculated using thermodynamic equations as well as, e.g., the latent heat of the thermoplastic.

The heat of pyrolysis represents an additional safety factor to prevent transfer of heat during a cell runaway reaction. Pyrolysis occurs from the carbonization of the molten thermoplastic, and may be a function of the rate of temperature change experienced by the molten thermoplastic from a runaway cell. Providing the rate of temperature change is within a sufficient range, the carbonization process may result in the absorption of energy released from the cell.

By way of examples, the thermoplastic composition can have a melting point of 110° C. to 270° C., for example, 130° C., as determined in accordance with ASTM F2625-10 (2016). The thermoplastic composition can have a heat capacity of 1400 to 2400 kJ/kg K, for example, 2200 kJ/kg K, as determined in accordance with ASTM E1269-11 (2018). The thermoplastic composition can have a heat of fusion at least 120 J/g, as determined in accordance with ASTM F2625-10 (2016). The thermoplastic composition can have a pyrolysis temperature of at least 300° C., as determined in accordance with ASTM D7309-20.

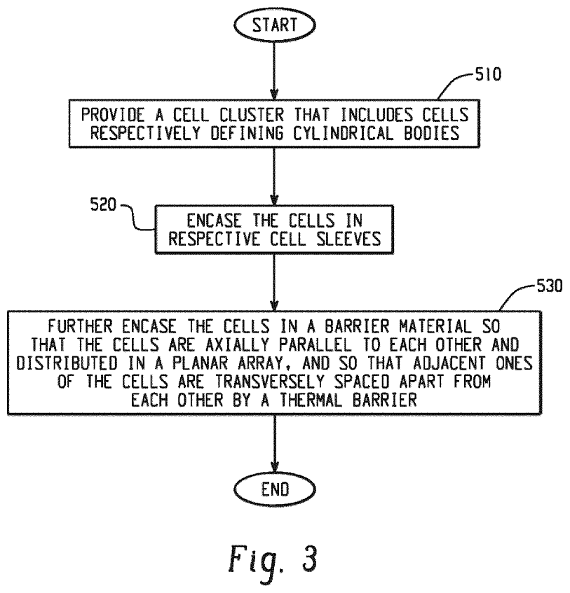

According to one example, a calculation of a configuration utilizing high density polyethylene as the olefinic thermoplastic and its properties (heat capacity of 2200 kJ/kg K and heat of fusion of 135 J/g) in an aluminum sleeve of 0.8 mm thickness (D1 in FIG. 1), indicates that the heat capacity (Cp) of 37 kJ can be achieved if the minimum thickness of the plastic (D2 in FIG. 1) is 3.5 mm and the local temperature is below the pyrolysis temperature of 400° C. For reference, the total thickness for consideration of heat absorption by the battery pack is DT=D1+D2 (FIG. 3), which is 4.3 mm. This heat capacity would be enough to absorb a release of heat energy of 36 kJ from a runaway cell. It is noted that values for the material properties identified herein are obtained from, e.g., Handbook of Polyethylene, Andrew Peacock, Marcel Dekker Inc, New York 2000, and/or CRC Handbook of Chemistry and Physics, 97th ed, CRC Press, Boca Raton 2017.

According to another example, more generic calculation is shown below in Table 1, which lists material properties of the battery cell, the aluminum heat spreader (or sleeve), and the thermoplastic barrier for a relatively higher density material. In this case the minimum thickness is reduced to 2.5 mm. It is noted that this example is provided merely as illustrative and is not intended to limit the present battery pack in any way.

TABLE 1

| | | | | Energy |
|---|---|---|---|---|
| Material | Cell | Sleeve | Plastic | Absorbed |
| DT (mm) | | 0.8 (D1) | 2.5 (D2) | |
| Diameter (mm) | 18 | | | |
| Height (mm) | 65.2 | | | |
| Volume (mm³) | 16591 | 6312 | 24942 | |
| Density (g/cm³) | | 2.7 | 1.2 | |
| Mass (kg) | | 17 | 30 | |
| Cp (J/(kg ° C.)) | | 897 | 2000 | |
| Tm (° C.) | | 700 | 120 | |
| (dt = 400° C.) | | | | |
| dH (J/g) | | | 300 | |
| (during phase | | | | |
| change) | | | | |
| −E [released] | −36 | +6 | +24 (pre-phase | +3 (additional |
| vs. +Cp | | | change) | energy capable |
| [absorbed] | | | +9 (from phase | of being |
| (kJ) (approx. | | | change) | absorbed) |
| values) | | | | |

In the table, a cylindrical battery cell having a diameter (Dia), height (Ht) and volume (Vol) as listed can release 36 kJ of energy. The sleeve having a material thickness D1 (FIG. 1A) of 0.8 mm, and based on a size that encases the cell, provides the listed volume of the sleeve per battery cell. The thickness D2 (FIG. 1A) of the thermoplastic of 2.5 mm, which is the minimum thickness achieved between two neighboring cells. Based on a size of the thermoplastic that encases the battery cell and sleeve, this thickness for D2 of the thermoplastic the provides the listed volume of the thermoplastic between adjacent cells. The thickness DT (FIG. 1B) represents the combination of D1 and D2, which for reference is 3.3 mm (total). The respective densities (Den) of the sleeve and thermoplastic are listed, as are the respective masses (Mass) due to the identified volumes.

The specific heat capacities (cp) for the sleeve and thermoplastic are listed, representing their respective abilities to absorb heat while remaining in a solid phase. The melting temperatures (Tm) of the sleeve and thermoplastic are listed. As indicated, the total change in temperature (400° C.) during a runaway battery cell event can be less than the melting temperature of the sleeve (700° C.). Thus, the sleeve will absorb 6 kJ of heat energy while remaining in its solid phase during a cell runaway event. However, the thermoplastic has a lower melting temperature and will melt, as intended, enabling it to absorb additional heat due to its heat of enthalpy (dH). The thermoplastic will absorb 24 kJ of heat energy while a solid, and then another 9 kJ from the transition to a liquid (molten) phase. Thus, the combination of the sleeve and thermoplastic can absorb up to 39 kJ of heat energy (6 kJ+24 kJ+9 kJ), which is above (by approximately 3 kJ) the 36 kJ of heat energy released from the runaway cell. As can be appreciated, this configuration can prevent heat energy from one runaway battery cell from impacting an adjacent battery cell.

A sleeve (not illustrated) can be provided between the cell 120 and the sleeve 125. The sizing and thickness of the thermoplastic spacer 150 can be the primary design parameter of the battery pack 100. The sleeve 125 can be made as thin as possible under manufacturing constraints, which can be a function of the heat transfer characteristics of the sleeve material. Thus, the calculations involving DT account only for the sizing of the thermoplastic spacer 150, which can be sized to absorb a desired portion of heat energy generated by a cell or cells 120 during a runaway event.

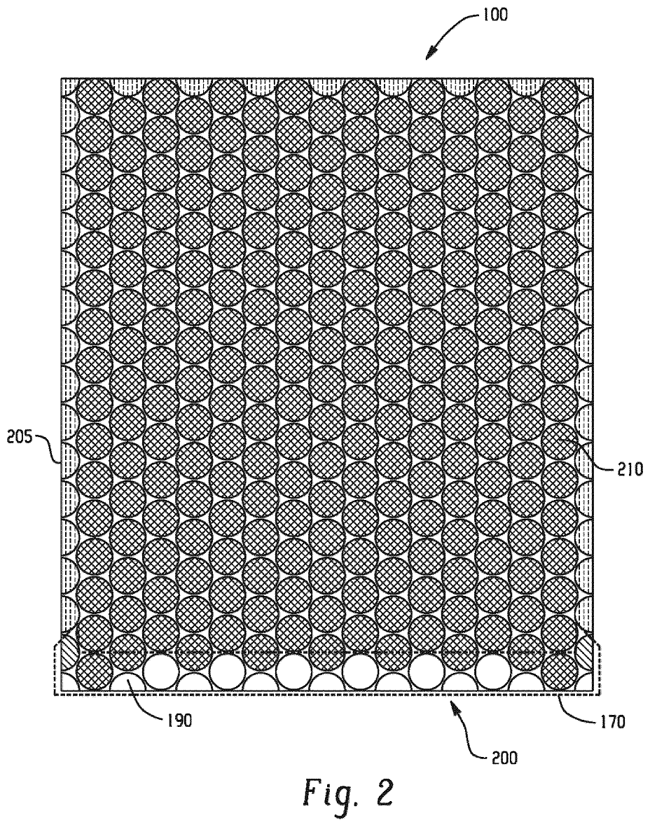

Referring now to both FIGS. 1 and 2, an impact barrier 170 can be formed by the thermoplastic spacer 150, along a transverse outer boundary 180 of the cell group 110. The impact barrier 170 can be formed along one or more outer boundary sides 200 of the battery pack 100. The impact barrier 170 can define a third transverse impact spacing of D3, wherein D3>D2. The impact barrier 170 can define one or more empty cylindrical recesses 190, where each of the one or more empty cylindrical recesses 190 being sized to seat one of the cells. The impact barrier 170 can enable the absorption of external impact energy which can otherwise transferred to the cells 120, which can therefore further reduce the possibility of a cascading runaway reaction.

Turning to FIG. 3, a flowchart shows a method of configuring the battery pack 100 disclosed above. As shown in block 510, the method includes providing a cell group 110. As shown in block 520, the method can include encasing the cells 120 in respective sleeves 125. As shown in block 530, the method can include further encasing the cells 120 in a thermoplastic spacer 150 so that the cells 120 are axially parallel to each other and distributed in a planar array. As indicated, adjacent ones of the cells 120 are transversely spaced apart from each other to by a thermal barrier defining a spacing of D2 that can be formed by the thermoplastic spacer 150.

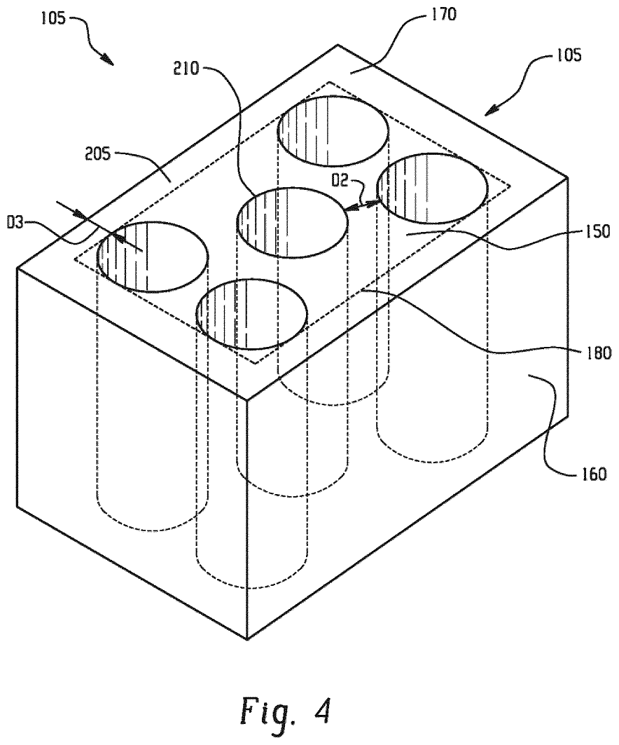

As shown in FIG. 4, an carrier system 105 utilized for the above identified group of cells 120 (FIGS. 1A-1B) can include a thermoplastic spacer 150, also known as a cell separator or cell spacer, forming a group of cylindrical recesses 210 respectively configured to receive the cells 120 (FIGS. 1A-1B) that are cylindrically shaped. The thermoplastic spacer 150 can be block shaped. The cylindrical recesses 210 are axially parallel to each other and distributed in a planar array. Adjacent ones of the cylindrical recesses 210 are transversely spaced apart from each other by the thermal barrier defining a spacing of D2 between the cylindrical recesses 210. In some examples D2 is at least 2.5 mm. The carrier system 105 can be formed of a monolithic thermoplastic. The carrier system 105 can molded in a single shot. Recesses can be machines in or molded in. In instances of molding, the recesses 210 can include a draft angle. The recesses 210 can include two draft angles, resembling an hourglass shape. A cross-section of the recesses 210 can define a frustoconical shape, with a larger base exiting co-planar with a major surface of the carrier system 105. A center apex of the cylinder can be sized to interference fit with a cell. The interior of the recesses 210 can include cell retaining features, such as detents, ribs, wedges, and the like. Axial channels can be disposed along the interior surface of the recesses.

The cylindrical recesses 210 can have the same size and shape as each other. An outer shell 160 can surround the thermoplastic spacer 150, where the outer shell 160 is formed of the sleeves 125, identified above. A carrier system 105 can be formed without an outer shell.

The thermoplastic spacer 150 can be formed of an olefinic thermoplastic. The thermoplastic spacer 150 can include a polyethylene. The thermoplastic spacer 150 can include a foaming agent that foams at approximately 240° C. to absorb heat energy.

An impact barrier 170 can be formed by the thermoplastic spacer 150, along a transverse outer boundary 180 of the group of cylindrical recesses 210. The impact barrier 170 can be formed along one or more outer boundary sides 200 of the thermoplastic spacer 150. The impact barrier 170 can define a transverse impact spacing of D3, wherein D3>D2. The impact barrier 170 can enable the absorption of external impact energy which can otherwise transferred to the cells 120, which can therefore further reduce the possibility of a cascading runaway reaction. Energy absorption features, such as honeycomb shapes, ribs, and the like can be defined in the impact barrier 170 to meet desired crush dynamics.

FIG. 5A illustrates a top view of cell testing apparatus, with no cover. FIG. 5B illustrates a side view of the cell testing apparatus of FIG. 5, shown in a cross-section taken at line B-B, with a cover showing in hidden line. The testing apparatus 500 consisted of a five-sided steel enclosure 502 and steel cap 504 with design considerations to allow measurement of enclosure pressure and temperature conditions as well as specific cell temperatures within an array of cells. The apparatus included a flow-restricting orifice in the enclosure wall to modulate pressure and to provide ventilation for combustion of gases ejected from cells during thermal runaway.

The apparatus 500 internal volume was designed to accommodate a 5×5 array of 18650 format cells and a variable amount of separation between each cell. The top 506 of the apparatus 500 was fabricated with a square flange 508 and ⅜″ threaded holes. The flange created a mating surface for a ¼″ thick cap plate that was bolted onto the enclosure with a high temperature gasket (not shown) placed between the two mating surfaces. The cap 504 included threaded connections for temperature and pressure measurement instrumentation. A 16 mm threaded orifice was inserted into the 2″ NPT hole 511 on the side of the enclosure. The presence of the threaded orifice can produce a thrust that pushes the test enclosure. Therefore, the test enclosure was fabricated with brackets for bolting the enclosure to a rigid surface such as a heavy table.

Three different cell carriers were fitted to the test apparatus, corresponding to three different test arrangements. Each carrier included twenty five Panasonic NCR18650B li-ion cells in a 5×5 arrangement. The cells were 18650 format with Nickel Cobalt Aluminum (NCA) cathode chemistry. The cell used has been characterized to go into thermal runaway at approximately 180° C. with a ramp rate of 6° C./min. In all test arrangements, the cells were not electrically interconnected and were charged to 100 state of charge (SOC).

The following measurements were taken during each test: Internal pressure generated during a test, internal cavity temperature generated during a test, measured with a sheathed thermocouple, surface temperatures of two initiating cells that are driven into thermal runaway, and bottom surface temperatures of selected target cells in the cell array.

A 0-250 psig diaphragm pressure transducer 512 and sheathed Type K thermocouple 514 were installed into an NPT pipe attachment that was connected to the cap plate 504 via a ½″ NPT union. A second NPT union connection was used for attachment of epoxy-sealed instrument pass-throughs 516. The pass-throughs 516 were used to route a series of 30 AWG Type K thermocouples and two sets of heated power leads into the test apparatus. A two-part epoxy was used to seal the pass-throughs to pressure leakage. The 30 AWG thermocouples were installed on the bottom of a subset of cells within the cell array using a spot-welding method to attach the junction to the cell casing and an instant adhesive for added strain relief for the fine wires forming the junction. The two power leads supplied current to two film heaters used to drive two initiating cells into thermal runaway. Two additional 30 AWG Type K thermocouples were used to control heating of the initiating cells and to measure their surface temperature.

When the cell array was placed in the test enclosure, the cells and their respective 30 AWG thermocouples were arranged in the layout shown in FIG. 5A. The cells numbered 1-15 were instrumented with thermocouples. The unnumbered cells were not instrumented with thermocouples. Two cells near the center of the cell array, labeled H1 and H2, were fitted with 28 V, 10 W/in² film heaters. These two cells were heated concurrently with a parallel heater circuit. Control of the two initiating cells in the cell array was achieved using a PID feedback system consisting of a National Instruments cDAQ data module, a DC power supply, and software. The approach of using two adjacent initiating cells is based on established practice for initiating thermal runaway propagation in a 5×5 cell array per UL 2596: Test Method for Thermal and Mechanical Performance of Battery Enclosure Materials.

During a test, the cell array was placed on ⅛″ ceramic fiber insulation and all thermocouple leads were run from the cell bottoms, up the side of the enclosure volume and out the epoxy-sealed pass-through. The extra space surrounding the cell array was filled with ceramic fiber insulation, except for a 1-inch gap between the cell array and enclosure wall with the threaded orifice. A noncombustible shim was used to maintain the 1-inch gap. This gap was provided to allow exhaust ventilation through the threaded orifice.

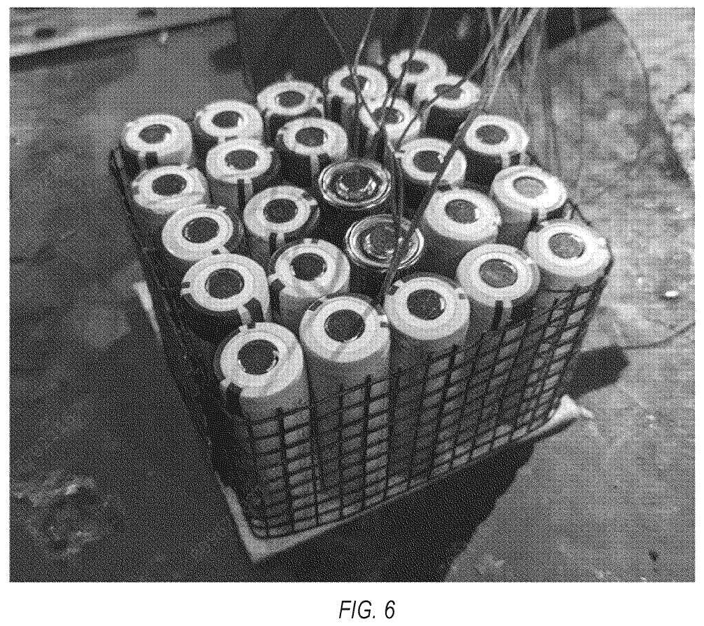

FIG. 6 illustrates an experimental cell carrier, with no air gap between cells. The configuration includes a 25-cell array with all cells nested together as closely as possible. The 25-cell array was contained within a wire mesh cage on four sides to keep the cells in as close contact as possible. This configuration was used for tests 1-4, discussed below.

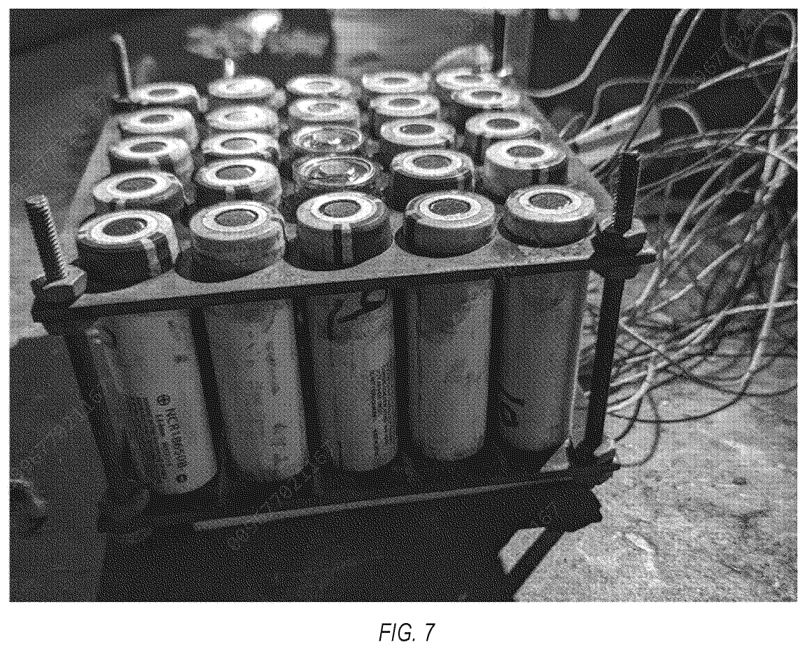

FIG. 7 illustrates an experimental cell carrier, with an air gap between cells. The configuration includes a 25-cell array with a 2 mm air gap between all cells. The 25-cell array was installed in a fixture consisting of two 1/16″ steel plates and four threaded rods. The plates were machined to provide through-holes for the cells and keep them separated by 2 mm, measured from the outermost point of adjacent cell circumferences This configuration was used for tests 5-7, discussed below.

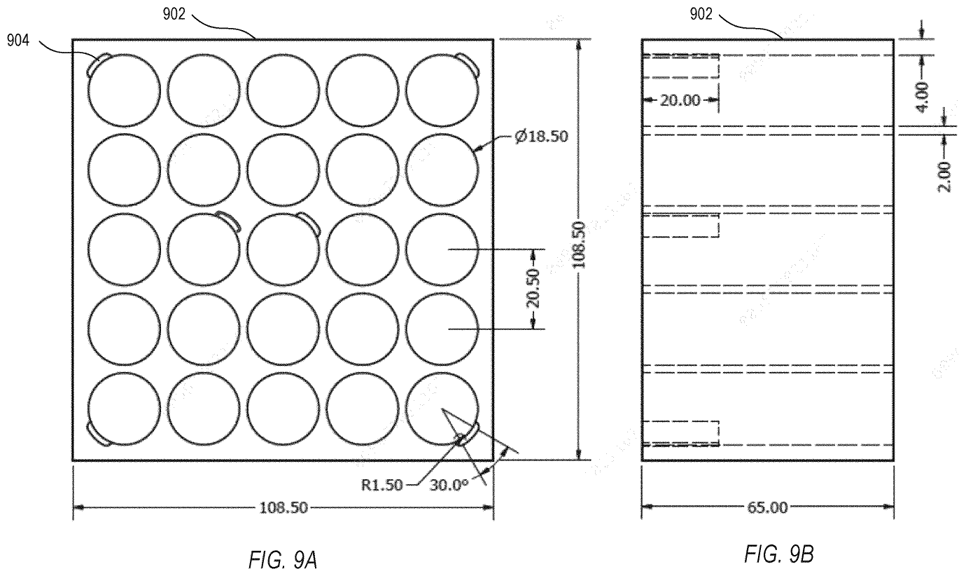

FIG. 8 illustrates an experimental cell carrier, with spaced apart cells disposed in a thermoplastic cell spacer. FIG. 9A illustrates a top view of an experimental thermoplastic cell separator of FIG. 8. FIG. 9B illustrates a side view of the experimental thermoplastic cell separator of FIG. 9A. A 25-cell array features 2 mm of separator material between adjacent cells. The 25-cell array was installed in a cell separator 902 with the same cell separation dimensions as the 2 mm air gap. The test material was machined based on the dimensions shown. Notches 904 were placed adjacent to cell slots where initiating cells could potentially be placed to allow for the heater leads and thermocouple. The central cell slot and a cell slot directly adjacent to the central slot are used for the locations of initiating cells into thermal runaway. This configuration was used for tests 8-10, discussed below.

The arrangements show in FIGS. 6-8 were each tested in the apparatus of FIG. 5 to generate comparative data. They are shown in perspective view for reference. The purpose of testing the FIG. 6 and FIG. 7 arrangements was to provide baselines for comparison against the performance of the thermoplastic separator of FIG. 8. The severity of thermal runaway in terms of enclosure conditions and the extend of thermal runaway propagation (number of cells in the array driven into thermal runaway) were compared among the three test types. The test arrangement indicated in FIG. 5A and FIG. 5B was consistent regardless of the test type. At least three trials of each test type were performed. Ten total tests were conducted, with at least three repeat tests of each test type completed. Table 2 shows the test matrix.

TABLE 2

| Test Number | Test Type |
|---|---|
| 1 | Closely Nested |
| 2 | Closely Nested |
| 3 | Closely Nested |
| 4 | Closely Nested |
| 5 | Air Gap |
| 6 | Air Gap |
| 7 | Air Gap |
| 8 | Separator Material |
| 9 | Separator Material |
| 10 | Separator Material |

Each test followed the same procedure. A test procedure would simultaneously initiate data collection at 10 Hz and heating of the initiating cells. A test would heat the two initiating cells using a parallel circuit at a set rate of 6° C./min, using the thermocouple on H1 as the reference thermocouple, until thermal runaway is observed in both initiating cells. The test procedure would persist until all measured temperatures inside the test enclosure had fallen below the vent temperature of the cells. The cells test apparatus was then opened and the cells were inspected.

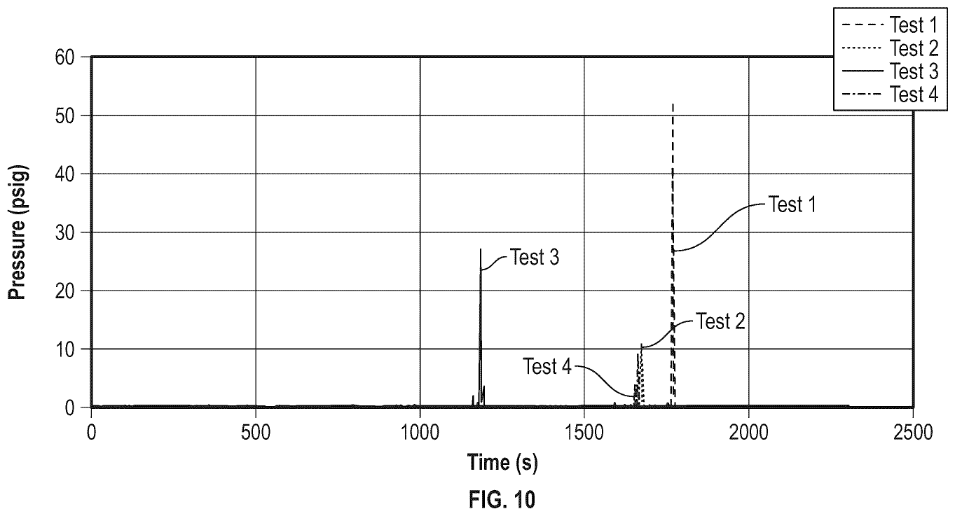

Table 3 provides an overview of metrics from each test conducted. The descriptions of FIGS. 10-15 provide details on the results of each test type.

TABLE 3

| | | | Peak | Target cells |
|---|---|---|---|---|
| | | Peak | sheathed | in thermal |
| | | Enclosure | thermocouple | runaway |
| Test | | Pressure | temperature | (not including |
| Number | Test Type | [psig] | [° C.] | initiators) |
| 1 | Closely | 52.3 | 561 | 23 |
| | Nested | | | |
| 2 | Closely | 11.0 | 540 | 23 |
| | Nested | | | |
| 3 | Closely | 27.1 | 446 | 23 |
| | Nested | | | |
| 4 | Closely | 9.3 | 435 | 23 |
| | Nested | | | |
| 5 | Air Gap | 17.4 | 241 | 23 |
| 6 | Air Gap | 20.6 | 200 | 23 |
| 7 | Air Gap | 13.3 | 226 | 23 |
| 8 | Separator | 2.16 | 103 | 0 |
| | Material | | | |
| 9 | Separator | 1.4 | 116 | 0 |
| | Material | | | |
| 10 | Separator | 6.2 | 159 | 0 |
| | Material | | | |

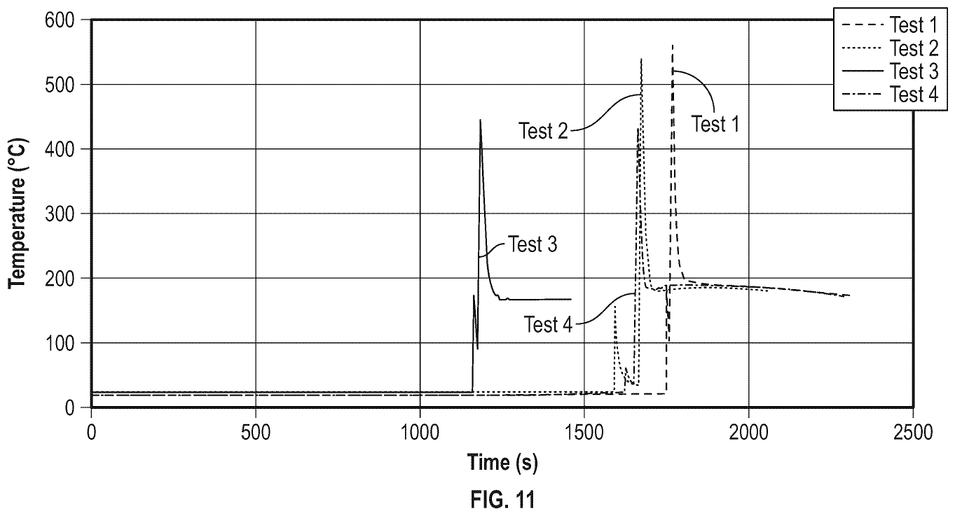

FIG. 10 shows pressure measurements for tests 1 through 4. FIG. 11 shows temperature measurements for tests 1-4. Four baseline tests were conducted with cells closely nested. Tests 1-4 resulted in complete thermal runaway propagation through the cell array. Complete propagation was indicated by all measured cell temperatures increasing past 180° C., enclosure pressure rise and visual inspection of cells post-test. Immediately after thermal runaway propagation, cell array temperatures were approximately 900° C.

Test 3 included an erroneously high ramp rate of initiating cell temperature above 6° C. per second. While the increased rate did not observably affect the test outcome regarding thermal runaway severity, an additional test (Test 4) was conducted with the correct rate of cell heating.

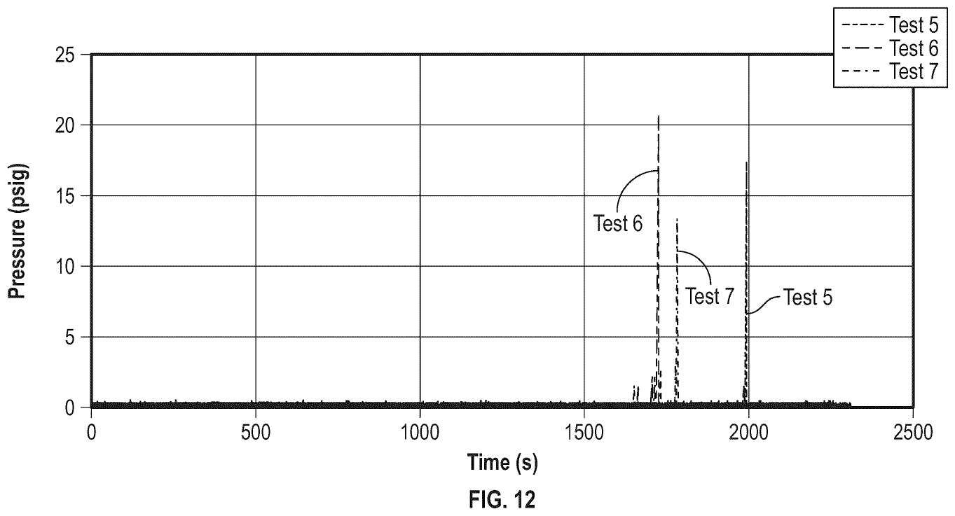

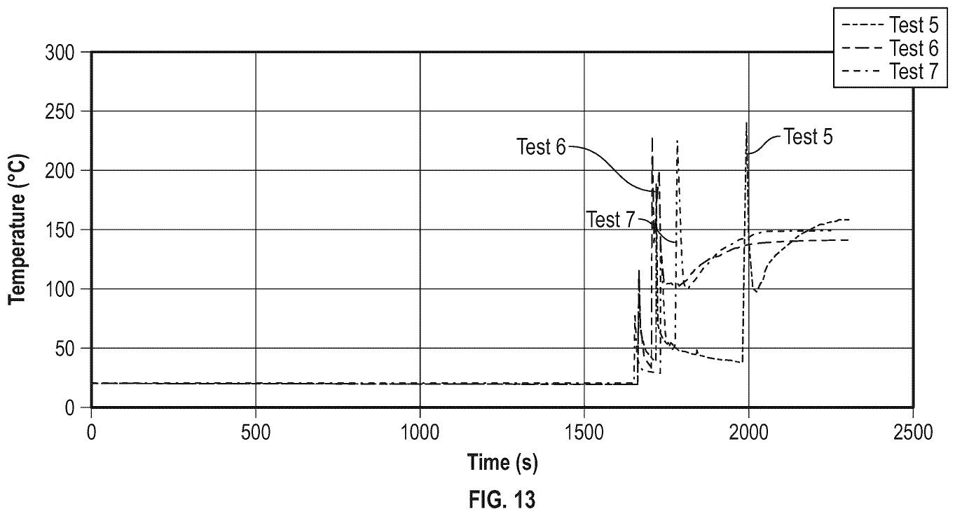

FIG. 12 shows pressure measurements for tests 5-7. FIG. 13 shows temperature measurements for tests 5-7. Three baseline tests were conducted with a 2 mm air gap. Tests 5-7 resulted in complete thermal runaway propagation through the cell array. Complete propagation was indicated by all measured cell temperatures increasing past 180° C., enclosure pressure rise and visual inspection of cells post-test. Immediately after thermal runaway propagation, cell array temperatures were approximately 800° C.

Compared to the closely nested cell baseline test series, peak sheathed thermocouple temperatures and enclosure pressures were lower in the air gap test series. Peak cell array temperatures were also lower by approximately 100° C., on average. However, the 2 mm air gap did not hinder the progression of cascading thermal runaway, compared to the closely nested cells, in terms of the number of cells that entered thermal runaway.

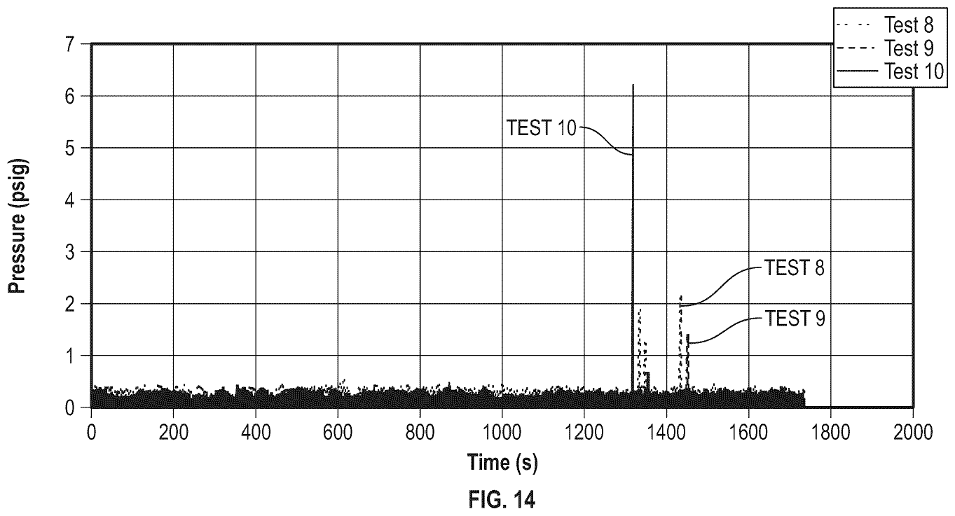

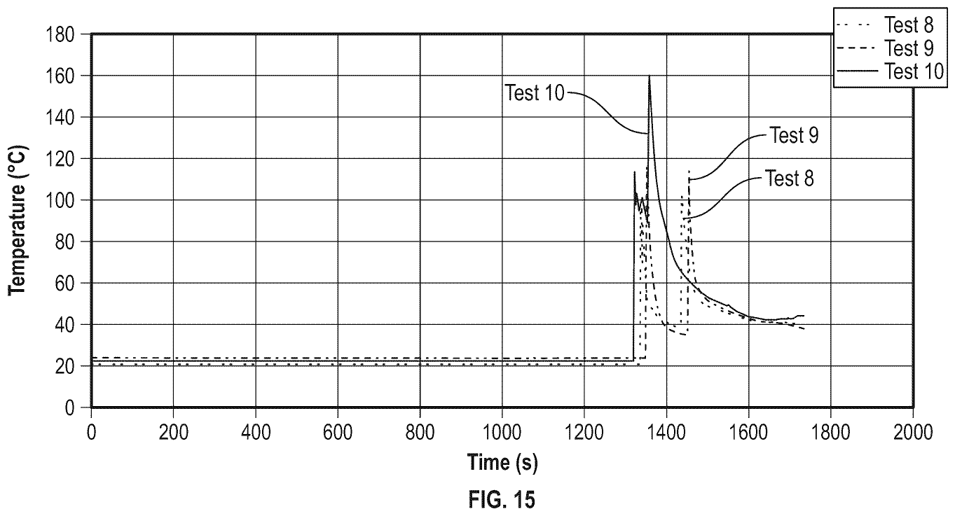

FIG. 14 shows pressure measurements for tests 8-10. FIG. 15 shows temperature measurements for tests 8-10. Three tests were conducted with the test material. Peak enclosure pressure and sheathed thermocouple measurements were lower than both baseline test series. Test 8 and 9 did not result in propagation of thermal runaway beyond the two initiating cells based on cell array thermocouple data, enclosure pressure data and visual inspection of the cells post-test. Cell temperatures from all instrumented cells 1-15 did not rise above 150° C. for either Test 8 or Test 9. A user error caused the heater system data acquisition to cut out briefly during Test 9. The acquisition was restarted with no observable effects.

Cell array thermocouple data from Test 10 gave disparate temperature results compared to cell array thermocouple data from Tests 8 and 9. The data of cells 3, 6, 7, 9, 11, 12, and 14 showed sharp spikes in temperature but with decay profiles inconsistent with thermal runaway temperatures in the baseline tests. Data of cells 1, 2, 4, 5, 8, 10, 13 and 15 indicated similar temperature profiles to the target cells in Test 8 and 9. Inspection of the target cells post-test did not indicate signs of thermal runaway-such as rupturing of cell casings-among cells beyond the two initiating cells. A possible cause of the data discrepancies is an electrical disturbance caused by the initiating cells going into thermal runaway. At the point of thermal runaway, an overload condition was caused in the cell heater power supply and data system. Air gap or material separation distances lower or higher than 2 mm or a different cell layout, such as a honeycomb pattern, may have produced different results.

The above disclosed aspects involve the utilization of thermoplastic latent heat of fusion enthalpy as a thermal barrier, which can absorb the energy of a battery cell short circuit and deter further propagation in a cell pack (e.g. a group of cells). The heat of pyrolysis of the thermoplastic will provide a second safety barrier to further propagation.

As used herein, “a,” “an,” “the,” and “at least one” do not denote a limitation of quantity, and are intended to cover both the singular and plural, unless the context clearly indicates otherwise. For example, “an element” has the same meaning as “at least one element,” unless the context clearly indicates otherwise. The term “combination” is inclusive of blends, mixtures, alloys, reaction products, and the like. Also, “at least one of” means that the list is inclusive of each element individually, as well as combinations of two or more elements of the list, and combinations of at least one element of the list with like elements not named. “Or” means “and/or.” The suffix “(s)” as used herein is intended to include both the singular and the plural of the term that it modifies, thereby including one or more of that term (e.g., the film(s) includes one or more films). Reference throughout the specification to “one aspect”, “another aspect”, “an aspect”, and so forth, means that a particular element (e.g., feature, structure, and/or characteristic) described in connection with the aspect is included in at least one aspect described herein, and may or may not be present in other aspects. In addition, it is to be understood that the described elements can be combined in any suitable manner in the various aspects.

1. A battery pack, comprising:
a plurality of cells, each defining an exterior with a height surface extending between upper and lower base surfaces,
the plurality of cells arranged in a cell group such that respective lower base surfaces are aligned parallel with one another, wherein each of the cells is associated with thermal runaway potential energy and a thermal runaway ignition energy that includes a cell heating capacity; and
a cell carrier, comprising:
a plurality of sleeves, each having a sleeve thickness D1, with each of the plurality of cells disposed in a sleeve, wherein each sleeve is associated with sleeve thermal resistance associated with a sleeve heat capacity; and
a thermoplastic spacer formed of thermoplastic and joined with the plurality of sleeves to define the cell carrier, wherein the thermoplastic spacer comprises a thermoplastic thermal resistance associated with a pre-pyrolysis heat capacity including a latent heat of fusion, and a pyrolysis heat capacity,
wherein the cell carrier defines cell-to-cell spacing D2 between adjacent cells, and for each cell the respective base surfaces are exposed while respective height surfaces are shielded from the height surfaces of adjacent cells by the cell carrier,
wherein:
the cell-to-cell spacing D2 is greater than the sleeve thickness D1, each of the plurality of cells is encased in the sleeve and further encased in the thermoplastic spacer;
the sleeves are formed of aluminum;
the thermoplastic spacer is formed of the thermoplastic and a foaming agent;
an impact barrier is formed by the thermoplastic spacer, along a transverse outer boundary of the cell group, along the outer boundary sides of the battery pack, and the impact barrier defines a third transverse impact spacing of D3, wherein D3>D2; and
the impact barrier defines one or more empty cylindrical recesses,
wherein:
material properties of the thermoplastic spacer include one or more of:
a melting point of 110° C. to 270° C. as determined in accordance with ASTM F2625-10 (2016);
a heat capacity of 1400 to 2400 kJ/kg K as determined in accordance with ASTM E1-269-11 (2018);
a heat of fusion at least 120 J/g as determined in accordance with ASTM F2625-10 (2016); or
a pyrolysis temperature of at least 300° C. as determined in accordance with ASTM D7309-20.

2. The battery pack of claim 1, wherein:
the cells have a same size and shape as each other; and
an outer shell surrounds the thermoplastic spacer.

3. The battery pack of claim 1, wherein: the thermoplastic spacer comprises a polyolefin and a foaming agent.

4. The battery pack of claim 1, wherein:
the thermoplastic spacer is formed of a spacer of thermoplastic that comprises cylindrical recesses respectively configured to receive the cells.

5. The battery pack of claim 1, wherein:
D2 is at least 2.5 mm; and
DI is 0.5 to 1.5 mm.

6. The battery pack of claim 1, wherein:
D2 is at least 3.5 mm.

7. The battery pack of claim 1, wherein:
each of the cells is cylindrical; and
each of the one or more empty cylindrical recesses being sized to seat one of the cells.

8. A method of configuring the battery pack of claim 1, comprising:
providing the cell group,
wherein the cell group includes cells respectively defining cylindrical bodies;
encasing the cells in respective sleeves; and
further encasing the cells in the thermoplastic spacer so that the cells 120 are axially parallel to each other and distributed in a planar array, and
wherein adjacent ones of the cells are transversely spaced apart from each other by the thermal barrier defining the spacing of D2 that is formed by the thermoplastic spacer.

9. A carrier system, comprising:
a thermoplastic spacer, forming a group of cylindrical recesses respectively configured to receive cells that are cylindrically shaped;
wherein the cylindrical recesses are axially parallel to each other and distributed in a planar array, and
wherein adjacent ones of the cylindrical recesses are transversely spaced apart from each other by a thermal barrier defining a spacing of D2 between the cylindrical recesses,
D2 is at least 2.5 mm, and;
wherein:
the thermoplastic spacer is formed of the thermoplastic and a foaming agent;
each of the plurality of recesses encases one of a plurality of sleeves that are formed of aluminum;
an impact barrier is formed by the thermoplastic spacer, along a transverse outer boundary of the group of cylindrical recesses;
the impact barrier is formed along one or more outer boundary sides of the thermoplastic spacer; and
the impact barrier defines a transverse impact spacing of D3, wherein D3>D2, and the impact barrier defines one or more empty cylindrical recesses.

10. The system of claim 9, wherein:
the cylindrical recesses have a same size and shape as each other; and
an outer shell surrounds the thermoplastic spacer.

11. The system of claim 9, wherein
material properties of the thermoplastic spacer include one or more of:
a melting point of 110° C. to 270° C. as determined in accordance with ASTM F2625-10 (2016);
a heat capacity of 1400 to 2400 kJ/kg K as determined in accordance with ASTM El-269-11 (2018);
a heat of fusion at least 120 J/g as determined in accordance with ASTM F2625-10 (2016); or
a pyrolysis temperature of at least 300° C. as determined in accordance with ASTM D7309-20.

12. A battery pack, comprising:
a plurality of cells, each defining a cylindrical exterior with a cylinder height surface extending between a pair of opposing base surfaces, the plurality of cells arranged in a cell group such that each cell center axis is parallel to that of adjacent cells, wherein each of the cells is associated with thermal runaway potential energy and a thermal runaway ignition energy that includes a cell heating capacity;
a thermoplastic spacer formed of a thermoplastic and defining a plurality of cylindrical recesses, with each of the plurality of sleeves disposed in the plurality of recesses and defining cell-to-cell spacing D2 between adjacent cells, wherein for each cell the respective base surfaces are exposed while the respective cylinder height surfaces are shielded from other cylinder height surfaces by the thermoplastic spacer, and
a plurality of sleeves, each having a sleeve thickness D1, with each of the plurality of cells disposed in a sleeve defining an air gap between the thermoplastic spacer and each respective cell; and
wherein the air gap is associated with an air gap thermal resistance associated with an air gap heat capacity, and
wherein the sleeve is associated with a sleeve thermal resistance associated with a sleeve heat capacity, and
wherein:
the cell-to-cell spacing D2 is greater than the sleeve thickness D1, each of the plurality of cells is encased in the sleeve and further encased in the thermoplastic spacer;
the thermoplastic spacer is formed of the thermoplastic and a foaming agent;
an impact barrier is formed by the thermoplastic spacer, along a transverse outer boundary of the cell group, along the outer boundary sides of the battery pack, and the impact barrier defines a third transverse impact spacing of D3,
wherein D3>D2; and
the impact barrier defines one or more empty cylindrical recesses,
wherein:
material properties of the thermoplastic spacer include one or more of: a melting point of 110° C. to 270° C. as determined in accordance with ASTM F2625-10 (2016);
a heat capacity of 1400 to 2400 kJ/kg K as determined in accordance with ASTM El-269-11 (2018);
a heat of fusion at least 120 J/g as determined in accordance with ASTM F2625-10 (2016); and/or
a pyrolysis temperature of at least 300° C. as determined in accordance with ASTM D7309-20.

13. The battery pack of claim 1, wherein
the impact barrier defines a plurality of the empty cylindrical recesses.

14. The battery pack of claim 1, wherein
material properties of the thermoplastic spacer include each of:
the melting point of 110° C. to 270° C. as determined in accordance with ASTM F2625-10 (2016);
the heat capacity of 1400 to 2400 kJ/kg K as determined in accordance with ASTM E1-269-11 (2018);
the heat of fusion at least 120 J/g as determined in accordance with ASTM F2625-10 (2016); and
the pyrolysis temperature of at least 300° C. as determined in accordance with ASTM D7309-20.

15. The method of claim 8, wherein
the thermoplastic spacer is block shaped, and
the method includes comprising surrounding the thermoplastic spacer in a shell formed of a same material as the sleeves.

16. The system of claim 9, wherein
the impact barrier is formed along a plurality of the outer boundary sides of the thermoplastic spacer.

17. The system of claim 9, wherein
the impact barrier defines a plurality of the empty cylindrical recesses.

18. The system of claim 11, wherein
material properties of the thermoplastic spacer include each of:
the melting point of 110° C. to 270° C. as determined in accordance with ASTM F2625-10 (2016);
the heat capacity of 1400 to 2400 kJ/kg K as determined in accordance with ASTM El-269-11 (2018);
the heat of fusion at least 120 J/g as determined in accordance with ASTM F2625-10 (2016); and
the pyrolysis temperature of at least 300° C. as determined in accordance with ASTM D7309-20.

19. The battery pack of claim 12, wherein
the impact barrier defines a plurality of the empty cylindrical recesses.

20. The battery pack of claim 12, wherein
material properties of the thermoplastic spacer include each of:
the melting point of 110° C. to 270° C. as determined in accordance with ASTM F2625-10 (2016);
the heat capacity of 1400 to 2400 kJ/kg K as determined in accordance with ASTM El-269-11 (2018);
the heat of fusion at least 120 J/g as determined in accordance with ASTM F2625-10 (2016); and
the pyrolysis temperature of at least 300° C. as determined in accordance with ASTM D7309-20.
